(19) United States
(12) Patent Application Publication
(10) Pub. No.: US 2025/0189222 A1
(43) Pub. Date: Jun. 12, 2025

(54) ACCESSORY DEVICE AND DRYING ASSEMBLY

(71) Applicant: SZ ZUVI TECHNOLOGY CO., LTD., Shenzhen (CN)

(72) Inventors: Tongyao HUANG, Shenzhen (CN); Mingyu WANG, Shenzhen (CN); Jinwei SONG, Shenzhen (CN)

(73) Assignee: SZ ZUVI TECHNOLOGY CO., LTD., Shenzhen (CN)

(21) Appl. No.: 19/006,260

(22) Filed: Dec. 31, 2024

Related U.S. Application Data
(63) Continuation of application No. PCT/CN2023/137953, filed on Dec. 11, 2023.

(51) Int. Cl. F26B 3/28; A45D 20/12; F26B 3/30

(52) U.S. Cl. CPC F26B 3/283; A45D 20/122; F26B 3/30; A45D 2200/205

(57) ABSTRACT

An accessory device (10) and a drying assembly (100) are provided. The accessory device (10) is installed in the drying apparatus (20) and the drying apparatus (20) is capable of emitting airflow and infrared radiation, and the accessory device (10) comprises a mounting portion (11), an airflow portion (12) and a guide component (13), the mounting portion (11) is configured for mounting to the drying apparatus, and the airflow portion (12) comprises an air inlet. The guide chamber (121) and the air outlet form a hollow portion between the airflow portion (12) and the mounting portion (11), and the guide component (13) is configured in the guide chamber (121), wherein the mounting portion (11) and the airflow portion (12) are connected to each other by a first connector (141).

### CROSS-REFERENCE TO RELATED APPLICATIONS

This application a Continuation application of International Application No. PCT/CN2023/137953, filed on Dec. 11, 2023, the entire contents of which are incorporated herein by reference.

### TECHNICAL FIELD

The present disclosure relates to the field of drying apparatus, in particular to an accessory device and a drying assembly.

### BACKGROUND

In the prior art, there is a drying apparatus capable of simultaneously emitting infrared radiation and hot airflow. After the traditional nozzle is designed to only consider the heat resistance to the hot airflow, after installing it in the above-mentioned drying apparatus, some areas of the nozzle will absorb infrared radiation and the energy of the hot airflow at the same time and heat up rapidly, and deform and melt after exceeding the heat resistance limit, resulting in damage to the nozzle. Moreover, overheated nozzles are also easy to cause safety accidents such as burns.

### SUMMARY

The present disclosure provides an accessory device and drying assembly designed to solve the problem that the nozzle in the prior art is prone to overheating damage.

The accessory device configured in the present disclosure is installed in the drying apparatus, the drying apparatus may output airflow and infrared radiation, the accessory device comprises a mounting portion, an airflow portion and a guide component, the mounting portion is configured for attaching to the drying apparatus, the airflow portion comprises an air inlet, a guide chamber and an air outlet, a hollow portion is configured between the airflow portion and the mounting portion, and the guide component is located in the guide chamber. The mounting portion and the airflow portion are connected to each other by a first connector, and the airflow portion and the guide component are connected to each other by a second connector.

The present disclosure also provides a drying assembly, including a drying apparatus and an accessory device, the end of the drying apparatus comprises an air outlet for emitting airflow and a radiation element for emitting infrared radiation; the accessory device is detachably attached to the drying apparatus, the air inlet corresponds to the air outlet portion, and the hollow portion corresponds to at least part of the radiation element.

When the accessory device in the present disclosure are used with the drying apparatus, the accessory device forms an independent airflow transmission path and an infrared radiation transmission path, and there is no area that is both flowed by the hot airflow and irradiated by the infrared radiation, so that the risk of local rapid overheating may be avoided by absorbing the heat of the airflow and the infrared radiation energy at the same time. The first connector and the second connector may not only connect and support the airflow portion, the mounting portion and the diversion portion, but also may form a heat transfer path, and may disperse the heat to the whole when the accessory device is overheated locally, so as to avoid the problem of overheating and damage of the accessory device.

Additional aspects and advantages of the embodiment of this application will be given in part in the description below, and part will become apparent from the description below, or as known through the practice of this application.

### BRIEF DESCRIPTION OF THE DRAWINGS

The foregoing and/or additional aspects and advantages of the present disclosure will become apparent and readily understood from the detailed description of the embodiments in conjunction with the following accompanying drawings, wherein:

FIG. 1a and FIG. 1b are schematic drawings of a drying assembly in some embodiments of the present disclosure;

FIG. 2 is a schematic drawing of a drying apparatus in some embodiments of the present disclosure;

FIG. 3 is a schematic drawing of a three-dimensional structure of the accessory device in some embodiments of the present disclosure;

FIG. 4 is a schematic drawing of the three-dimensional structure in the other direction of the accessory device in some embodiments of the present disclosure;

FIG. 5 is a schematic drawing of the direction of the air inlet of the accessory device in some embodiments of the present disclosure;

FIG. 6 is a schematic drawing of the direction of the air outlet of the accessory device in some embodiments of the present disclosure;

FIG. 7 is a schematic drawing of the coverage of an accessory device in some embodiments of the present disclosure;

FIG. 8 is a schematic drawing of a section formed in a first direction of the accessory device in some embodiments of the present disclosure;

FIG. 9 is a schematic drawing of an accessory device formed in a second direction in some embodiments of the present disclosure;

FIG. 10 and FIG. 11 are schematic drawings of a structure of the diversion portions in some embodiments of the present disclosure.

### DETAILED DESCRIPTION

The embodiments of the present disclosure are described in detail below, and examples of said embodiments are shown in the drawings wherein the same or similar designations denote the same or similar elements or elements having the same or similar functions throughout. The embodiments described below by reference to the drawings are illustrative and are intended to explain the embodiment of the present disclosure only and shall not be construed as a limitation on the embodiment of the present disclosure.

In the description of this disclosure, it is necessary to understand that the terms “center”, “longitudinal”, “horizontal”, “length”, “width”, “thickness”, “up”, “down”, “front”, “back”, “left”, “right”, “vertical”, “horizontal”, “top”, “bottom”, “inner”, “outside”, “clockwise”, “counterclockwise”, such orientation or positional relationship indicated is based on the orientation or positional relationship shown in the drawings, only for the convenience of describing the present disclosure and simplifying the description, and does not indicate or imply that the apparatus or element referred to must have such specific orientation, be constructed and operated in such particular orientation, and therefore may not be construed as a limitation on the present disclosure. In the description of this disclosure, “plurality” means two or more than two, unless otherwise expressly and specifically qualified.

In the description of the present disclosure, it is noted that, unless otherwise expressly specified or qualified, the terms “attached”, “connected”, “connected” are to be understood broadly, for example, they may be fixed, detachable, or integrally connected. It may be mechanically or electrically connected. It may be directly connected or indirectly connected by an intermediate medium, it may be the internal connection of two elements or the interaction relationship between two elements. For those of ordinary skill in the art, the specific meaning of the above terms in the present disclosure may be understood on a case-by-case basis.

In the present disclosure, unless otherwise expressly specified and qualified, the first feature “above” or “below” the second feature may include direct contact between the first and second features, or the first and second features are not in direct contact but through additional feature contact between them. Moreover, the first feature is “above”, “over”, and “on top of” the second feature includes the first feature directly above and obliquely above the second feature, or simply indicates that the first feature is horizontally higher than the second feature. The first feature is “below”, “under”, and “beneath” the second feature, including the first feature directly below and diagonally below the second feature, or simply indicating that the horizontal height of the first feature is less than that of the second feature.

The publication of this disclosure provides a number of different embodiments or examples to implement the different structures of the present disclosure. In order to simplify the disclosure of the present disclosure, the parts and settings for specific examples are described in this disclosure. They are only examples and are not intended to limit the present disclosure. In addition, the present disclosure may repeat the reference numbers and/or reference letters in different examples, and this repetition is for the purpose of simplification and clarity and does not in itself indicate the relationship between the various embodiments and/or settings in question. In addition, the present disclosure provides examples of various specific processes and materials, but those of ordinary skill in the art may be aware of the present disclosure of other processes and/or the use of other materials.

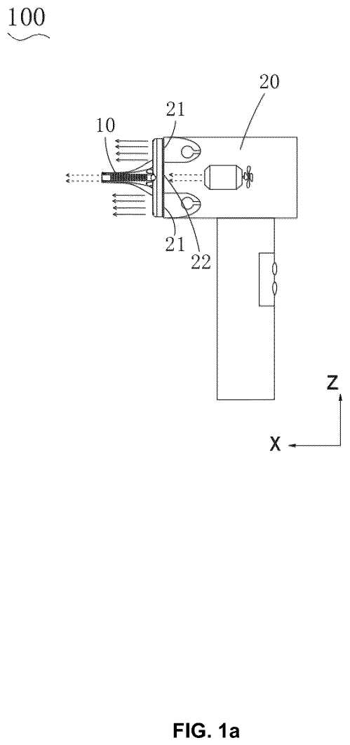

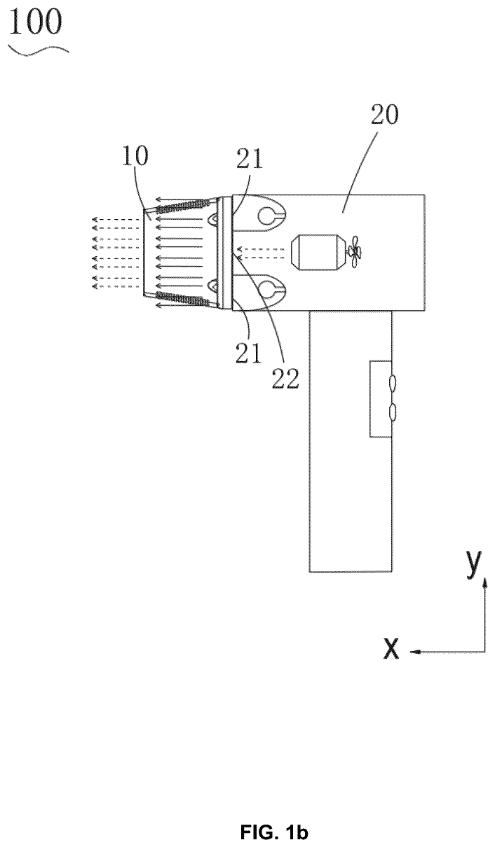

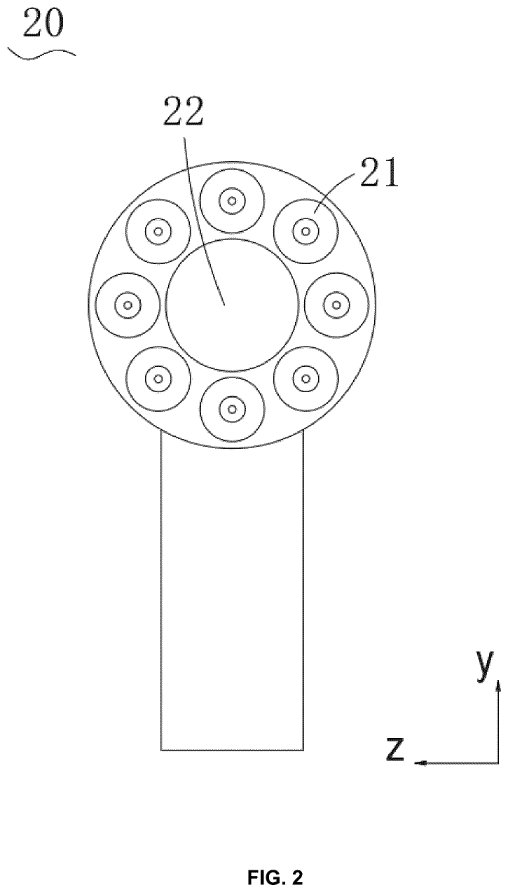

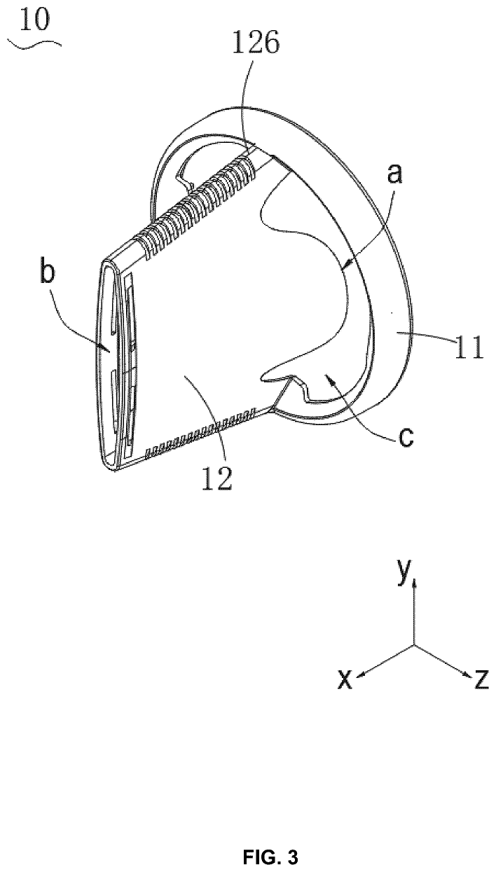

As shown in FIG. 1a, FIG. 1b, FIG. 2 and FIG. 3, an accessory device 10 is configured in some embodiments of the present disclosure, which may be detachably attached to the drying apparatus 20 and is configured for regulating the airflow of the drying apparatus 20.

A drying apparatus 20 concerned in the present disclosure comprises a radiation element and an airflow assembly. One end of the drying apparatus 20 comprises an air outlet portion 22 for emitting airflow and a radiation element 21 for generating infrared radiation. The drying apparatus 20 emits airflow or hot airflow from the air outlet portion 22 during operation, and generates infrared radiation from the radiation element 21. These two, after traversing along the preset transmission path, dry an object to be dried. In order to ensure a better drying effect, the drying apparatus 20 emits airflow and generates infrared radiation in the following designed way: both form a roughly overlapping coverage area at a preset distance, where the water around the coverage area is rapidly evaporated by the combined action of airflow, radiation and heat. To take hair drying for an example, infrared radiation protects the hair from damage caused by high-temperature baking during hair drying using a drying apparatus 20.

After the accessory device 10 is attached to the drying apparatus 20, the airflow of the drying apparatus 20 may be adjusted. Specifically, the accessory device 10 may change at least one parameter of an output airflow of the drying apparatus 20, which comprises airflow speed, airflow direction, airflow shape, airflow path, divergence or convergence degree, etc. During hair drying with the drying apparatus 20, different airflows may achieve different results. For example, hot flat airflow is suitable for styling hair; slow diffusing airflow may give hair dried a voluminous feel; and fast converging airflow may keep hair straight and supple during hair drying.

In addition, because the drying apparatus 20 also generates infrared radiation, in order to ensure that the object to be dried may be subject to the combined action of airflow, radiation and heat simultaneously, the accessory device 10 shall avoid blocking the infrared radiation as much as possible while adjusting the airflow according to needs. In other words, the accessory device 10 shall be configured to allow as much infrared radiation as possible to pass through while regulating the airflow.

In each accompanying drawing of the present disclosure, a partial transmission path of the infrared radiation is denoted as a solid line arrow, and a partial airflow transmission path is denoted as a dotted line arrow. It shall be noted that although the infrared radiation and the output airflow from the drying apparatus 20 have different divergence angles, the transmission direction of the two may be roughly the same, which are all referred as an airflow direction X. The relevant structures of the accessory device 10 and the drying apparatus 20 are described below in combination with the airflow transmission path and the infrared radiation.

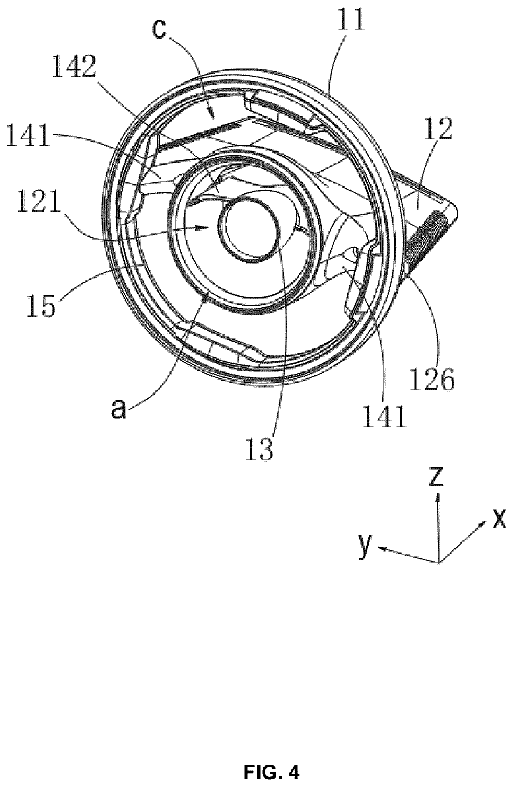

As shown in FIG. 2, FIG. 3 and FIG. 4, the accessory device 10 specifically comprises a mounting portion 11, an airflow portion 12 and a guide component 13. When the mounting portion 11 is configured for attaching to the drying apparatus 20, the accessory device 10 keeps attaching to the drying apparatus 20 mutually. The mounting portion 11 may at least provide sufficient attaching strength, positioning accuracy, so that the accessory device 10 may be used with the drying apparatus 20 with stability maintained. In some embodiments, the accessory device 10 may rotate at any angle along an axial direction, while still mutually attaching to the drying apparatus 20. The mounting portion 11 may attach to the drying apparatus 20 mutually by magnetic attraction, threads, annular buckles, etc., which specific structure is not the focus of the present disclosure. If there is no specific description below, the accessory device 10 and the drying apparatus 20 are mutually attached. Other parts on the accessory device 10 form attaching, and/or coupling relationship with and the mounting portion 11, which may be regarded as these parts positioned relative to the drying apparatus 20 in a preset position.

The airflow portion 12 is configured with an air inlet a, a guide chamber 121 and an air outlet b. The position of the air inlet a corresponds to the air outlet portion 22 of the drying apparatus 20. The guide component 13 is configured in the guide chamber 121. The output airflow of the drying apparatus 20 enters the airflow portion 12 from the air inlet a, passes along an outer surface of the guide component 13 and an inner surface of the guide chamber 121, and leaves the accessory device 10 from the air outlet b to dry an object finally. The shape and size of the guide component 13, the guide chamber 121 and the air outlet b may all have an impact on the airflow parameter, so as to adjust the airflow of the drying apparatus 20.

A hollow portion c is configured between the airflow portion 12 and the mounting portion 11. The hollow portion c corresponds to at least part of the radiation element 21. At least part of the infrared radiation generated by the radiation element 21 of the drying apparatus 20 may transmit through the hollow portion c and project on the object to be dried.

As shown in FIG. 4, the mounting portion 11 and the airflow portion 12 are coupled to each other by a first connector 141. Because a hollow portion c is configured between the mounting portion 11 and the airflow portion 12, the first connector 141 itself spans through an internal space of the hollow portion c, at least part of which is in the transmission path of infrared radiation. The energy of the infrared radiation thereby will be absorbed and its temperature may rise. Thus, the total amount of infrared radiation passing through the accessory device 10 and projecting on the object may approximately equal to the total amount of infrared radiation entering the hollow portion c minus the portion covered by the first connector 141. As mentioned above, the accessory device 10 is configured to allow as much infrared radiation to pass through as possible, so that the accessory device 10 comprises no structure in the airflow direction X other than the first connector 141 located in the hollow section c. Alternatively, when there are other structures located in the hollow section c, it is configured to roughly coincide with the first connector 141 in the airflow direction X in order to minimize the blocking of infrared radiation.

The airflow portion 12 and the guide component 13 are coupled to each other by a second connector 142, at least a part of which is in the airflow transmission path and exchanges heat with the airflow. When the drying apparatus 20 emits a hot airflow, the second connector 142 may absorb the heat of the hot airflow and its temperature may rise.

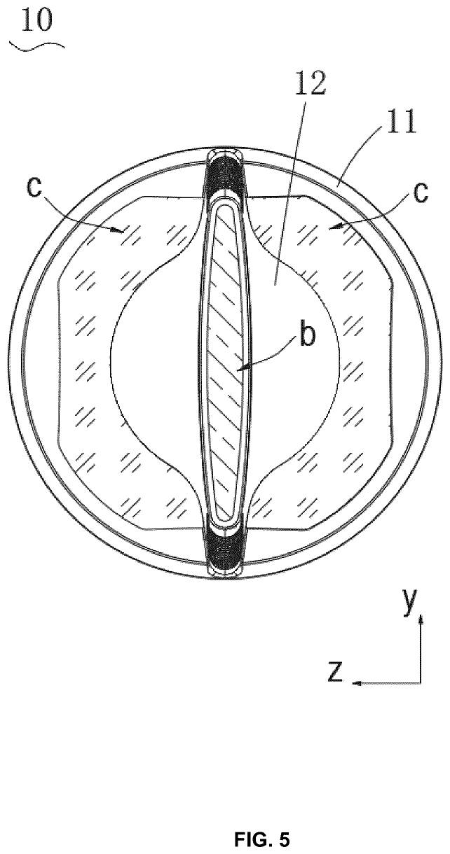

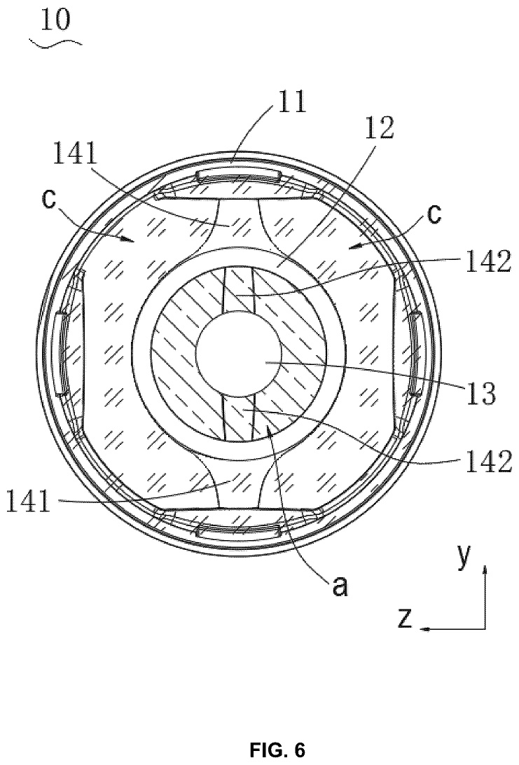

As shown in FIG. 5 and FIG. 6, the part covered by the outlet airflow and infrared radiation at air inlet a and air outlet b is denoted by different lines in the drawings. Combined with FIG. 4, an airflow transmission path and an infrared radiation transmission path may independently be configured in the accessory device 10:

The guide chamber 121 in the airflow portion 12 forms the airflow transmission path. When the drying apparatus 20 is in operation, the output airflow may pass along the above-mentioned transmission path. Specifically, it may pass through an inner surface of the airflow portion 12, an outer surface of the guide component 13, and an outer surface of the second connector 142. When the drying apparatus 20 emits a hot airflow, these areas may absorb the heat of the airflow and their temperature may rise. For the purposes of the present disclosure, “area” means at least part of a certain surface. Even at the same location of the same structure, different surfaces (e.g., the inner and outer surfaces of the airflow portion 12) are different areas, which will not be repeated below.

The hollow portion c between the airflow portion 12 and the mounting portion 11 forms a transmission path of the infrared radiation. When the drying apparatus 20 is in operation, the output infrared radiation may irradiate at least part of an outer surface of the airflow portion 12, at least part of an outer surface of the mounting portion 11, and at least part of an outer surface of the first connector 141. These areas may absorb infrared radiation energy and their temperature may rise.

It may be seen that, in the above-mentioned various embodiments, the guide component 13 and the second connector 142 are only affected by the airflow, while the mounting portion 11 and the first connector 141 are only affected by the infrared radiation. Although the airflow portion 12 is affected by both the airflow and the infrared radiation, no area of the airflow portion 12 affected by the two overlaps. Some areas of the outer surface of the airflow portion 12 are affected by infrared radiation, and the inner surface is affected by the airflow.

In other words, when the drying apparatus 20 outputs hot airflow and generate infrared radiation, there is no area on the entire accessory device 10 that is both transversed by the hot airflow and the infrared radiation, thereby avoiding any local area simultaneously absorbing heat from the airflow and the infrared radiation energy, and the risk of rapid heating and overheating. In this way, the overall heat resistance requirements of the accessory device 10 may be reduced during design, thereby reducing the cost of the accessory device 10.

In addition, the first connector 141 and the second connector 142 are respectively located within the infrared radiation transmission path and the airflow transmission path. These two connectors not only support and couple the corresponding structure, but also constitute a heat transfer path, which disperses the heat absorbed from the infrared radiation or the hot airflow, so as to further avoid the local overheating of the accessory device 10.

Specifically, when the drying apparatus 20 emits a hot airflow with a high temperature, any part of the inner surface of the airflow portion 12, the guide component 13 and the second connector 142 is heated to super high temperature by the hot airflow. The heat may be transmitted to the first connector 141 along the airflow portion 12, and then transmitted to the mounting portion 11 from the first connector 141, thereby distributing the heat from the hot airflow to the entire accessory device 10. It not only reduces the local temperature rise of the accessory device 10, but also increases the heat dissipation area.

In the same way, when the drying apparatus 20 generates infrared radiation with higher power, any of the first connector 141 and the outer surface of the airflow portion 12 is heated to super high temperature by the infrared radiation. The heat may be transmitted to the mounting portion 11 and the airflow portion 12 along the first connector 141, and then transmitted to the guide component 13 from the airflow portion 12 through the second connector 142, thereby distributing the heat from the infrared radiation to the entire accessory device 10. It not only reduces the local temperature rise of the accessory device 10, but also increases the heat dissipation area.

When the drying apparatus 20 emits a low-temperature hot air flow or a normal temperature air flow, the heat exchange process between the air flow and each areas it passes through is equivalent to a heat dissipation process. Thereby, the inner surface of the airflow portion 12, the guide component 13, and the second connector 142 are in dissipating heat continuously. After the heat absorbed by the outer surface of the airflow portion 12 and the first connector 141 from the infrared radiation is transferred to the second connector 142, the second connector 142 may be rapidly cooled down by the airflow, thereby reducing the overall temperature rise of the accessory device 10.

To sum up, it may be seen that when the accessory device 10 configured in the embodiment of the present disclosure is used in conjunction with the drying apparatus 20, the accessory device 10 may constitute an airflow transmission path and an infrared radiation transmission path that are independent of each other. The local area is avoided from being heated by both hot airflow and the infrared radiation simultaneously and the temperature from rising rapidly. Moreover, the first connector 141 and the second connector 142 may disperse the local high temperature of the accessory device 10 to the entire accessory device 10, so that the local overheating of the accessory device 10 may be further avoided.

In some more local embodiments, heat-resistant materials may be configured in an area passed through by the airflow in the accessory device 10 while reflective materials may be configured in an area irradiated by the infrared radiation, so as to reduce the temperature rise or increase the heat resistance in a more targeted manner.

In some more local embodiments, the outer surface of the airflow portion 12 is coated to make it have higher reflectivity, so that the infrared radiation absorbed by the outer surface of the airflow portion 12 is reduced, and the purpose of reducing the temperature rise is realized.

As shown in FIG. 1a, and FIG. 1b, some embodiments of the present disclosure also provide a drying assembly 100, comprising the above-mentioned drying apparatus 20 and the accessory device 10. A count of accessories 10 may be plural, with each changing airflow parameters in a different way. The user may select a corresponding accessory device 10 to attach to the drying apparatus 20 per his/her needs. Referring to the above, when the drying assembly 100 is used, the accessory device 10 may avoid the risk of rapid overheating in a local area caused by simultaneous absorption of airflow heat and infrared radiation energy, and achieving better overall heat resistance.

In some embodiments as shown in FIG. 5, the first connector 141 and the second connector 142 are coupled to opposite side walls of the airflow portion 12 at the same position. Although they are not in direct contact with each other, they may transfer heat to each other through the side wall of the airflow portion 12, so that the efficiency of heat transfer between the first connector 141 and the second connector 142 is improved. In some other embodiments not shown, the first connector 141 is directly coupled to the second connector 142, and the two are in contact with each other and connected, and therefore achieving a high heat transfer efficiency. In other embodiments, part of the first connector 141 and part of the second connector 142 is in contact and coupled, the other part is respectively coupled to an opposite side wall of the airflow portion 12 at the same position. The first connector 141, in this embodiment, and the second connector 142 may transfer heat to each other. In other embodiments, the first connector 141 and the second connector 142 are two parts of an integral connector, and may also be regarded as an integral connector directly coupling the mounting portion 11 with the guide component 13. The airflow portion 12 is also coupled to the integral connector. In the various embodiments, a thermal coupling may be configured between the first connector 141 and the second connector 142, and heat may be transferred from one of the two at a higher temperature to the other at a lower temperature. Therefore, the heat may be quickly dispersed to the entire accessory device 10 along the transfer path formed by the first connector 141 and the second connector 142.

In some embodiments shown in FIG. 5, in any plane perpendicular to an axis of the accessory device 10, the first connector 141 and the second connector 142 have the same extension direction. In this way, the heat transfer path formed by the first connector 141 and the second connector 142 is a straight path, so that the heat may be transmitted outward along the first connector 141 and the second connector 142 with high efficiency and dispersed to the entire accessory device 10, thereby reducing the risk of local overheating. In other embodiments, the first connector 141 and the second connector 142 may also have different extension directions, such as perpendicular to each other, forming an angle between each other, etc., to adapt to different structural design needs.

In some embodiments shown in FIG. 5, in any plane perpendicular to an axis of the accessory device 10, the first connector 141 and the second connector 142 extend radially along the accessory device 10 to form a shorter heat transfer path among the mounting portion 11, the airflow portion 12 and the guide component 13, so that the heat may be transferred between these three with higher efficiency and further dispersed to the entire accessory device 10, thereby reducing the risk of local overheating.

In some embodiments shown in FIG. 5, the number of the first connectors 141 may be two, and the number of the second connectors 142 may be two. In any plane perpendicular to an axis of the accessory device 10, all of the first connectors 141 and the second connectors 142 are configured symmetrically in a straight line along a radial direction of the accessory device 10. Taking the illustrated direction as an example, an upper and a lower half of the accessory device 10 comprise a first connector 141 and a second connector 142 respectively. The heat of each area of the upper half of the accessory device 10 is transmitted and dispersed through the first connector 141 and the second connector 142 located at the upper half; the heat of each area of the lower half of the accessory device 10 is transmitted and dispersed through the first connector 141 and the second connector 142 located at the lower half.

In some more specific embodiments, the cross-sectional shape of the accessory device 10 in the airflow direction X is annular. All first connectors 141 and second connectors 142 are configured along the peripheral of the annulus.

It is easy to understand that the more the number of the first connectors 141 and the second connectors 142, the higher the heat transfer efficiency is, and the higher the corresponding structural strength is, but the higher the degree of blocking of infrared radiation and airflow. In different embodiments, the first connector 141 and the second connector 142 may be designed in other numbers, such as three, five, six, etc. based on actual coupling strength requirement and heat transfer requirement. In other embodiments, the number of the first connectors 141 and the second connectors 142 may also be different. For example, there are four first connectors 141 and two second connectors 142. The two first connectors 141 are directly or indirectly thermally coupled to the second connector 142.

The infrared radiation output of the drying apparatus 20 will be diffused along its transmission path, causing its power density gradually decrease. Therefore, the closer the distance between the accessory device 10 and the radiation element 21 of the drying apparatus 20, the higher the power density of the infrared radiation received, and the greater the temperature rise. In order to reduce the temperature rise of the first connector 141 affected by the infrared radiation, in some embodiments, the shape of the first connector 141 is specially designed to increase the distance between the entire first connector 141 and the radiation element 21 in the airflow direction X as much as possible without changing its attaching manner and structural strength.

Specifically, in the embodiment as described in FIG. 4, part of the first connector 141 facing the radiation element 21 is bent in an arch shape along the airflow direction X. The area closer to the apex of the arch is farther away from the radiation element 21. Compared with a straight line extension, the arched first connector 141 may maintain the position of the original two end points, and increase the distance between the central area, without changing the original attaching position and attaching method of the mounting portion 11, and the airflow portion 12 and the radiation element 21 in the airflow direction X, thereby reducing the overall temperature rise affected by the infrared radiation.

In other embodiments, the part of the first connector 141 facing the radiation element 21 may be configured to extend along an inclined straight line or a curve, with its first end relatively close to the radiation element 21 and its second end relatively far away from the radiation element 21. Along the direction from the first end to the second end, the first connector 141 gradually moves away from the radiation element 21. In this way, the distance between the entire first connector 141 and the radiation element 21 in the airflow direction X may also be increased, so that the temperature rise may be reduced.

In some more specific embodiments, the first connector 141 may be made of heat-resistant material and configured to withstand higher temperature without deformation. In some more specific embodiments, the first connector 141 may be made of reflective material, or comprise a reflective surface on its surface by coating, pasting, etc., which can reflect most of the infrared radiation, reduce the amount of infrared radiation absorbed. The temperature rise of the first connector 141 thereby is reduced.

The hot output airflow of the drying apparatus 20 will diffuse along its transmission path, causing the power density to gradually decrease. Therefore, the closer the accessory device 10 is to the air outlet portion 22 of the drying apparatus 20, the greater the temperature rise caused by the hot airflow. In order to reduce the temperature rise of the second connector 142 affected by the hot airflow, in some embodiments, the shape of the second connector 142 is specially configured to increase the distance between the entire second connector 142 and the air outlet portion 22 in the airflow direction X on the premise of not changing its attaching manner and structural strength.

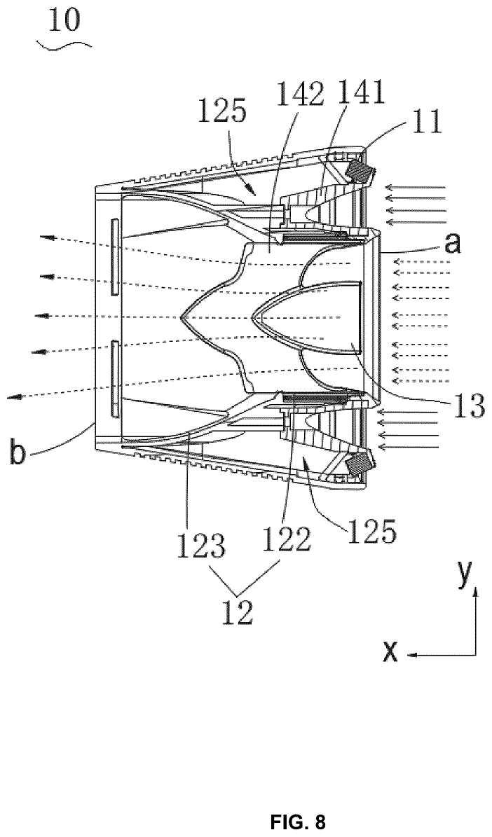

Specifically, in some embodiments shown in FIG. 4 and FIG. 8, part of the second connector 142 facing the air outlet portion 22 is configured to be curved and arched along the airflow direction X. Compared with the straight line extension, the arched second connector 142 may maintain the position of the original two ends, increase the distance between the airflow direction X and the air outlet portion 22 without changing the original attaching position and attaching manner of the airflow portion 12 and the guide component 13, thereby reducing the overall temperature rise caused by the hot airflow.

In other embodiments, the portion of the second connector 142 facing the air outlet portion 22 may be configured to extend along an inclined straight line or curve, with its first end located relatively close to the air outlet portion 22, and its second end located relatively far away from the air outlet portion 22. The second connector 142 is gradually away from the air outlet portion 22 along a direction of the first end towards the second end. In this way, it may be possible to increase the distance between the entire second connector 142 and the air outlet portion 22 in the airflow direction X, thereby reducing the temperature rise.

In some more specific embodiments, the second connector 142 is made of heat-resistant material and may withstand higher temperatures without deformation.

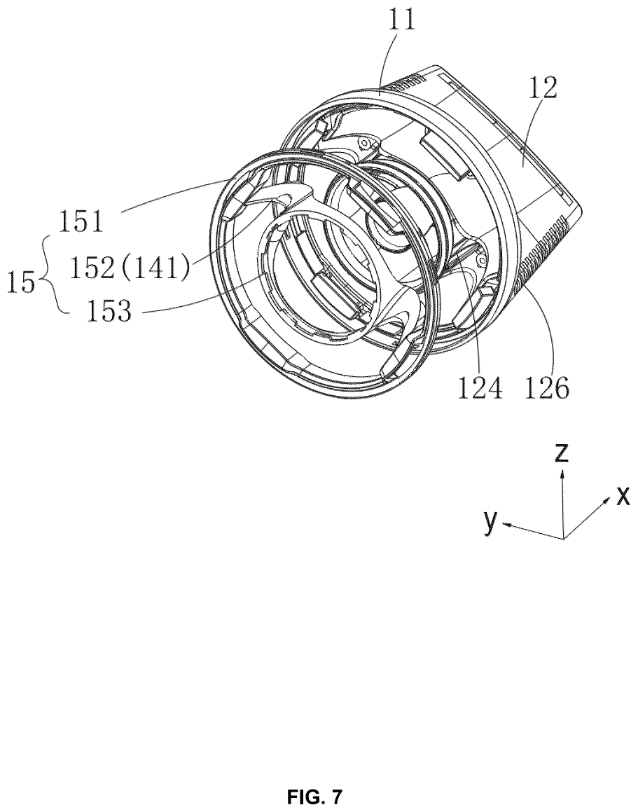

As shown in FIG. 7, the accessory device 10 in some embodiments further comprises a blocking piece 15, which comprises a first blocking portion 151, a second blocking portion 152 and a third blocking portion 153. The first blocking portion 151 covers an outer edge of the air inlet a and is configured for blocking infrared radiation for the airflow portion 12; the second blocking portion 152 spans through an internal space of the hollow portion c and forms a first connector 141; the third blocking portion 153 covers the end face of the mounting portion 11 facing the drying apparatus 20 and is configured for blocking the infrared radiation for the mounting portion 11.

Combined with FIG. 1a, FIG. 1b and FIG. 7, in a drying assembly 100 of some embodiments of the present disclosure, the infrared radiation of the drying apparatus 20 is directed as: one part passing through the hollow portion c, and the other part irradiating to the blocking piece 15. The drying apparatus 20 is configured with a reflector, a condenser or other related optical structure, which is used to limit the divergence angle and the direction of the infrared radiation, so that the infrared radiation may hardly irradiate to places other than the hollow portion c or the blocking piece 15.

The material used in the blocking piece 15 is different from that used in the other parts of the accessory device 10. In some embodiments, the blocking piece 15 is made of heat-resistant material that is capable of withstanding higher temperatures without deformation. In some embodiments, the blocking piece 15, made of reflective materials, may reflect most of the infrared radiation, thereby reducing its own temperature rise. In some embodiments, the blocking piece 15 may be made of metal such as aluminum, steel, etc., and may have both heat resistance and reflectivity. In some embodiments, the base material of the blocking piece 15 is made of heat-resistant material, and the surface of the substrate forms a reflective surface through processes such as electroplating, so that it comprises both heat resistance and reflective properties.

As may be seen from the foregoing, the accessory device 10 is close to an end of the drying apparatus 20, which is an area with the highest power density along the infrared radiation transmission path. After being covered by the blocking piece 15, the heat resistance may be strengthened or the infrared radiation may be reflected, thereby avoiding being heated locally by the infrared radiation to overheating deformation.

It shall be noted that heat-resistant and/or reflective materials generally have a higher material cost and require special processing techniques. The accessory device 10 will lead to higher costs if it is entirely made of heat-resistant and/or reflective materials. Therefore, the blocking piece 15 is made of a heat-resistant and/or reflective material to form a radiation facing surface of the accessory device 10 instead of forming the entire accessory device 10, which can reduce the cost of the accessory device 10 while still meeting the requirements of heat resistance.

In some embodiments shown in FIG. 4, the mounting portion 11 of the accessory device 10 may be annular. The airflow portion 12 is located inside the annular mounting portion 11. The hollow portion c configured between the two is ring-shaped or part of it is ring-shaped to correspond to the shape of the radiation field generated by the radiation element 21 of the drying apparatus 20 or the infrared radiation.

Correspondingly, as shown in FIG. 2, the end of the drying apparatus 20 in some embodiments of the present disclosure is circular. The circular central area forms the air outlet portion 22, and an outer edge of the air outlet portion 22 forms a ring-shaped radiation element 21. The radiation element 21 may comprise a single ring-shaped radiation source or a plurality of point-shaped radiation sources configured along a ring shape. Since the infrared radiation will be better guided, it is easy to achieve a smaller diffusion angle. In addition, the airflow is poorly guided, and it spreads at a large diffusion angle after emitting from the air outlet portion 22. The radiation element 21 at the end of the drying apparatus 20 is configured around the outside of the air outlet portion 22. After passing a preset transmission distance, the infrared radiation with a smaller diffusion angle and the airflow with a larger diffusion angle may form a roughly overlapping action area to jointly dry the area where the moisture is. Correspondingly, in the accessory device 10 as shown in FIG. 4, the hollow portion c is configured on the outer edge of the airflow portion 12.

In some embodiments as shown in FIG. 7, the first blocking portion 151 and the third blocking portion 153 of the blocking piece 15 may all be annular. The second blocking portion 152 (first connector 141) is coupled radially to the first blocking portion 151 and the third blocking portion 153. The second blocking portion 152 is coupled to the first blocking portion 151 and the third blocking portion 153 along the shortest path to shorten the heat transfer path inside the blocking piece 15 as much as possible. The relevant content may also refer to the description of the first connector 141 above.

In some embodiments as shown in FIG. 7, part of the area of the second blocking portion 152 is curved in an arch shape along the airflow direction X, so as to be as far away from the radiation element 21 as possible and reduce the temperature rise of the second blocking portion 152 after receiving the infrared radiation. The relevant content may also refer to the description of the first connector 141 above.

The attaching manner of the blocking piece 15 may be implemented by a variety of embodiments. In some specific embodiments, the first blocking portion 151 and the mounting portion 11 are fixed to each other by buckles, screws, magnetic connection, gluing, etc., so that the blocking piece 15 is integral as a whole. In some specific embodiments, the third blocking portion 153 and the airflow portion 12 are fixed with each other by buckles, screws, magnetic connection, gluing, etc., so that the blocking piece 15 is integral as a whole.

In the specific embodiment shown in FIG. 7, the second blocking portion 152 forms an arched part, and comprises a through hole at the apex of the arch. The second blocking portion 152 is fixed to the airflow portion 12 by a bolt (not shown) passing through the through hole. Since the apex of the arch is the furthest distance between the blocking piece 15 and the radiation element 21, putting the bolt here may minimize the impact of the infrared radiation on itself, thereby preventing the bolt forming a gap between itself and the airflow portion 12 during repeated thermal expansion and cooling contraction. Moreover, the apex of the arch is concave relative to the entire accessory device 10. The bolt may be hidden so as to reduce its influence on the appearance consistency of the accessory device 10.

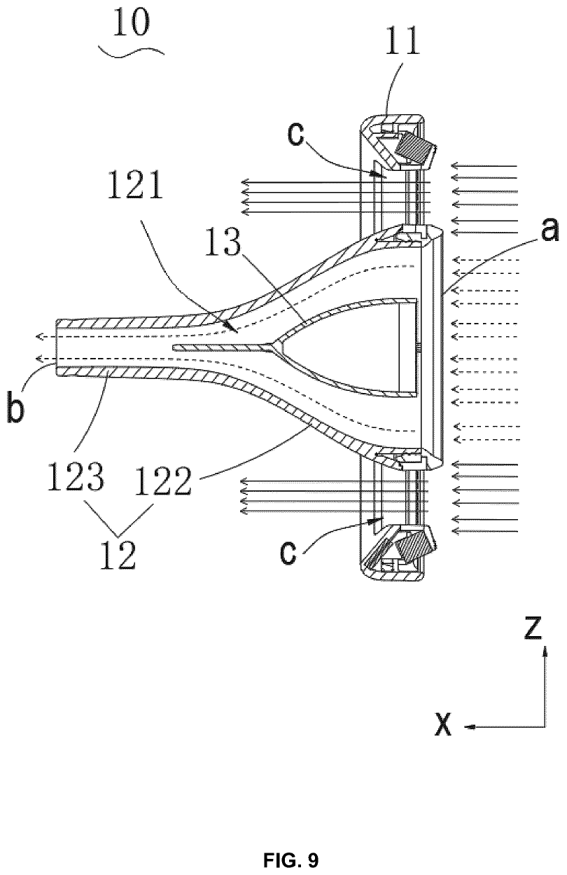

In some embodiments as shown in FIG. 8 and FIG. 9, the airflow portion 12 comprises an air inlet portion 122 and a diffusion portion 123. One end of the air inlet portion 122 forms the air inlet a. One end of the diffusion portion 123 is coupled to the air inlet portion 122, and the other end forms the air outlet b. The air inlet portion 122 gradually decreases in size along the airflow direction X while the diffusion portion 123 gradually expands in size along at least one direction of the airflow direction X.

After the airflow enters the air inlet portion 122 from the air inlet a, it is radially converged while passing, and then enters the diffusion portion 123. When the airflow passes along the diffusion portion 123, it diffuses along at least one direction, and the diffused airflow emits from the air outlet b.

As shown in FIG. 9, for the air inlet portion 122, because its radial size gradually decreases along the airflow direction X, the largest part of its radial size is near the air inlet a and is also the part of the air inlet portion 122 that's closest to the radiation element 21. The outer surface of the air inlet a may block most of the infrared radiation, and only a small part of the unblocked infrared radiation diffuses and irradiates on the outer surface of the airflow portion 12. The diffusion portion 123 is located relatively far away from an area with high power density of infrared radiation, and therefore it is less affected by the infrared radiation. For the entire airflow portion 12, it is only necessary to strengthen the heat resistance near the air inlet a to ensure that the outer surface of the air inlet portion 122 does not overheat due to the infrared radiation. In some specific embodiments, as mentioned above, the blocking piece 15 is made of heat-resistant and/or reflective materials. Its third blocking portion 153 blocks the air inlet a, thereby strengthening the heat resistance and reducing the temperature rise there. In some other specific embodiments, a reflective surface may be configured by coating on the outer edge of the air inlet a, thereby reducing its ability to absorb the infrared radiation.

In some embodiments, as shown in FIG. 1a or FIG. 1b, and FIG. 4, the accessory device 10 further comprises a sealing ring (not shown) configured at the air inlet a. The sealing ring is configured for forming a seal between the edge of the air inlet a and the drying apparatus 20. The sealing ring may ensure that all the output airflow of the drying apparatus 20 enters the internal channel of the airflow portion 12, and prevents the hot airflow from leaking to the outer surface of the airflow portion 12. If the hot air leaks, it will flow along the outer surface of the air inlet a, causing the hot airflow and the infrared radiation to heat the outer surface of the air inlet a simultaneously, which may cause rapid overheating. It may also be understood that when the accessory device 10 is used with the drying apparatus 20, there is no airflow in the hollow portion c.

The first direction y and the second direction z are introduced below for ease of description. In conjunction with the drawings of the present disclosure, the first direction y is perpendicular to the second direction z, and the plane (y, z) is perpendicular to the airflow direction X. It shall be noted that the airflow direction X shown in each drawing may be positive or negative, with the positive direction pointing to the downstream direction of the airflow. The first direction y and the second direction z do not indicate positive and negative properties, the arrows in the drawing are indicative only, and the positive and negative directions of the two are not distinguished below. In addition, the accessory device 10 may rotate at any angle relative to the drying apparatus 20. The first direction y and the second direction z are the directions determined based on the size of the accessory device 10, which have nothing to do with the drying apparatus 20. For example, two directions of attaching of the accessory device 10 are shown in FIG. 1a and FIG. 1b. In other embodiments not shown before, the accessory device 10 may also be attached in other directions to the drying apparatus 20.

As shown in FIG. 8, the diffusion portion 123 gradually expands in size on the first direction y, and the first connector 141 also extends in the first direction y. On the premise that the airflow needs to be directed to diffuse along the first direction Y, the first connector 141 and the diffusion portion 123 are configured to project in the airflow direction roughly together, so that the blocking of the infrared radiation by the accessory device 10 may be reduced, and the transmittance of the infrared radiation may be increased. Moreover, the first connector 141 may also form a blockage to the diffusion portion 123, reducing its temperature rise due to the infrared radiation. In some specific embodiments, as described above, in conjunction with FIG. 7, the blocking piece 15 is made of heat-resistant and/or reflective materials. The second blocking portion 152 itself may be heat-resistant or capable of reflecting infrared radiation, thereby reducing the temperature rise effect of infrared radiation on the diffusion portion 123.

In some embodiments shown in FIG. 4, FIG. 8 and FIG. 9, the guide component 13 is configured on an axis of the airflow portion 12. An annular air inlet a is configured between the guide component 13 and the airflow portion 12. When the output airflow of drying apparatus 20 passes through a guide chamber 121, the flow resistance near the side wall of the guide chamber 121 is larger, and the flow resistance at the axis position is smaller, which may lead to uneven airflow speed in the radial direction. After the guide component 13 is configured on the axis of the airflow portion 12, the flow resistance at the axis may be increased, making the airflow speed uniform everywhere in the radial direction of the airflow.

In some specific embodiments shown in FIG. 9, in the airflow direction X, the size of the diffusion portion 123 remains approximately the same along the second direction z. For example, the diffusion portion 123 has the same dimensions everywhere in the second direction z, or the size difference of the diffusion portion 123 in the second direction z is less than 20%, or the size change of the diffusion portion 123 in the second direction z is significantly smaller than the size change in the first direction y.

When the airflow passes through the diffusion portion 123, it diffuses along the first direction y, and its size remains approximately the same along the second direction z. It may also be understood that the airflow is directed from a cylindrical to a flat shape, the size of which in the first direction y is significantly greater than that in the second direction z. In FIG. 6, the shape inside the air outlet b is the shape of the airflow after it is directed. The flat airflow is suitable for styling with a hair comb during hair drying. Moreover, the flat diffusion component 123 has a smaller size in the second direction z, which may minimize the blocking of infrared radiation by the entire accessory device 10 along the second direction z.

According to the fluid mechanics, when the airflow passes through a cavity, the flow resistance is greater in the part close to the side wall of the cavity than the part away from the side wall of the cavity. If the radial size of the cavity is large, the airflow speed in the radial direction will be greatly different, which will affect the overall smoothness of the airflow. In order to avoid the above-mentioned situation, in the embodiment of the present disclosure, a guide component 13 is configured in the airflow portion 12 to reduce the radial size of the guide chamber 121 and avoid the formation of eddy current.

Specifically, in some embodiments as shown in FIG. 8 to FIG. 11, the guide component 13 comprises a first diversion portion 131 and a second diversion portion 132. At least part of the first diversion portion 131 is configured in the air inlet portion 122, with its radial dimensions gradually decreasing along the airflow direction X. At least part of the second diversion portion 132 is configured in the diffusion portion 123. The second diversion portion 132 separates the guide chamber 121 into two parts.

When the airflow passes through in the air inlet portion 122, it flows through an area between the outer surface of the first diversion portion 131 and the inner surface of the air inlet portion 122, forming an annular airflow guided to converge along the radial direction. Moreover, the airflow is divided into two parts by the second diversion portion 132, which further reduces the radial size of the airflow, thereby ensuring uniform airflow speed everywhere along the radial direction.

In some specific embodiments, the first diversion portion 131 and the second diversion portion 132 are integrally molded, which has lower manufacturing and assembly costs. In other embodiments, the first diversion portion 131 and the second diversion portion 132 may also be two independent parts, and the guide component 13 is assembled by bolts, gluing, buckles, etc.

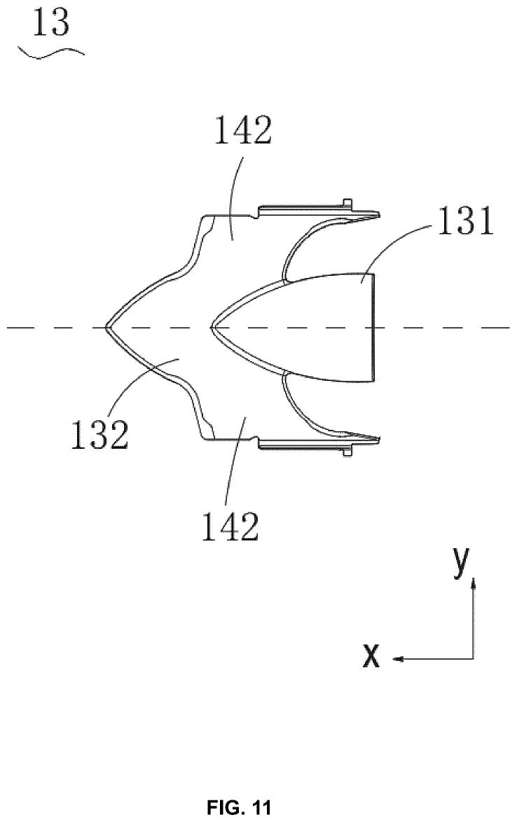

In some specific embodiments as shown in FIG. 8 and FIG. 11, a part of the second diversion portion 132 forms a second connector 142. As may be seen from the foregoing, the second connector 142 itself is configured between the guide component 13 and the airflow portion 12, so that the guide chamber 121 may be separated into two parts. In other words, the second connector 142 simultaneously fix the guide component 13 in the guide chamber 121 and avoid eddy currents.

In some embodiments shown in FIG. 9 to FIG. 11, the second diversion portion 132 is plate-shaped, and the size of at least part of its area along the second direction z remain the same, adapting to the shape of the diffusion portion 123, the two together guide the airflow to diffuse along the first direction y.

In some specific embodiments as shown in FIG. 8 to FIG. 10, the first diversion portion 131 is conical, and its end extends to form a first tip pointing to the air outlet b. The shape of the conical first diversion portion 131 and the air inlet portion 122 are adapted, and the two together form an annular chamber with gradually decreasing radial size to converge the airflow in the radial direction.

In some embodiments as shown in FIG. 8 and FIG. 11, along the airflow direction X: the end of the second diversion portion 132 decreases in size along the first direction y and forms a second tip pointing to the air outlet b; the diffusion portion 123 gradually expands along the first direction y. Since the size of the diffusion portion 123 increases along the first direction y, a vortex occurs when the airflow enters the diffusion portion 123 from the air inlet portion 122. The second diversion portion 132 that gradually decreases in size along the first direction y may be adapted to the second diversion portion 132 that gradually expands in size along the first direction Y, which may prevent the airflow from forming a vortex when diffusing along the first direction y.

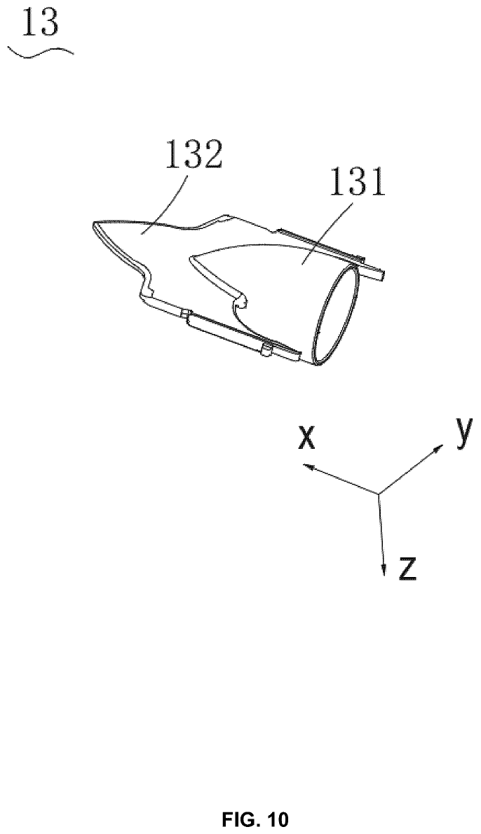

In some specific embodiments shown in FIG. 10 and FIG. 11, the guide component 13 and the guide chamber 121 are all axisymmetric structures and have the same axis of symmetry. In this way, the guide chamber 121 comprises the same airflow resistance along all radial directions. The airflow, as a result, may keep the same speed everywhere when passing through the guide chamber 121, and emits from the air outlet b in a relatively smooth state.

In some embodiments shown in FIG. 8, in the radial direction of the accessory device 10, a part of the outer edge of the second connector 142 is coupled to the inner wall of the air inlet portion 122, and the other part extends into the diffusion portion 123. Along the airflow direction, one end of the outer edge of the second connector 42 is configured at the air inlet a, and the other end is configured at the diffusion portion 123.

After the airflow enters the air inlet a, it is simultaneously guided by the first diversion portion 131 and the second diversion portion 132, both of which decrease in size along the radial direction and is divided into two parts, thereby changing the shape of the airflow while avoiding the formation of vortex.

Combined with the FIG. 8, FIG. 11 shows, in some specific embodiments, the part of the second connector 142 facing the air inlet a is configured to be curved and/or inclined, and its shape is roughly as follows: along the direction of the outer edge pointing to the axis, gradually moving away from the air inlet a. Because the hot output airflow of the drying apparatus 20 may diffuse along its transmission path and the power density will gradually decrease, the above mentioned curved and/or inclined second connector 142 may increase the distance between the entirety and the air inlet a while maintaining its original function, thereby reducing the temperature rise caused by the hot airflow.

In the accessory device 10 provided by some embodiments shown in FIG. 7 and FIG. 8, the airflow portion 12 comprises an outer side wall 126 and an inner side wall 124 in a part adjacent to the air inlet a. The air inlet a is configured inside the inner side wall 124. A thermal insulation chamber 125 is configured between the inner side wall 124 and the outer side wall 126. After the inner side wall 124 of the airflow portion 12 is heated by a hot airflow, the thermal insulation chamber 125 may block the heat from being directly transferred from the inner side wall 124 to the outer side wall 126, thereby avoiding the user being burned when touching the outer surface of the accessory device 10.

As shown in FIG. 8, in some more specific embodiments, the size of the thermal insulation chamber 125 decreases along the airflow direction X. Since the temperature of the hot airflow near the air inlet a is the highest, the position of the largest size of the thermal insulation chamber 125 corresponds to the best thermal insulation effect. The temperature of the hot airflow gradually decreases during flowing, and the size of the thermal insulation chamber 125 also decreases accordingly. The overall size of the accessory device 10 is reduced to satisfy the thermal insulation needs and increase the convenience of use.

As shown in FIG. 3, in some specific embodiments, the outer side wall 126 is coupled to the mounting portion 11 to form a connecting portion between the airflow portion 12 and the mounting portion 11. In this way, on the one hand, the degree of mounting stability between the airflow portion 12 and the mounting portion 11 may be increased, and on the other hand, the appearance consistency of the accessory device 10 is better.

In the embodiment shown in FIG. 4 and FIG. 5, along the radial direction of the accessory device 10, the extension direction of the first connector 141 coincides with the extension direction of the outer side wall 126. The first connector 141 may form a blockage on the outer side wall 126 to prevent infrared radiation from irradiating to the outer side wall 126 and the thermal insulation chamber 125, thereby increasing the transmittance of infrared radiation and reducing the temperature rise of the outer side wall 126.

In summary, the accessory device 10 and the drying assembly 100 are configured in each embodiment of the present disclosure, the accessory device 10 comprises an airflow portion 12 roughly flat, which may direct the output airflow of the drying apparatus 10 to a flat airflow. Moreover, because the size of the airflow portion 12 along the first direction y is significantly larger than that along the second direction z, the accessory device 10 blocks the infrared radiation only along the first direction y, and forms a hollow portion c between the airflow portion 12 and the mounting portion 10 along the second direction z, so that infrared radiation may pass through the outside of the airflow portion 12.

As shown in FIG. 5, when viewing the accessory device 10 from the direction of the air inlet a, it may form an infrared radiation transmission path and an airflow transmission path respectively to avoid overheating of the local area caused by the infrared radiation and the hot airflow simultaneously. Furthermore, in conjunction with the display shown in FIG. 7, the blocking piece that is heat-resistant or capable of reflecting infrared radiation covers all the radiation-facing surfaces of the accessory device 10 to prevent it from overheating and deformation caused by infrared radiation.

Referring to FIG. 6, when observing the accessory device 10 from the direction of the air outlet b, a flat airflow and a partially annular infrared radiation are emitted to the object, both of which act on the object to be dried to provide a unique drying effect.

In the description of this specification, references to the terms “one embodiment”, “some embodiments”, “schematic embodiments”, “examples”, “specific examples” or “some examples”, etc., are intended to mean that the specific features, structures, materials or features described in conjunction with the embodiments or examples are contained in at least one embodiment or example of the present disclosure. In this specification, indicative representations of the above terms do not necessarily refer to the same embodiments or examples. Further, the specific features, structures, materials, or features described may be combined in an appropriate manner in any one or more embodiments or examples. In addition, without contradicting each other, those skilled in the art may combine and combine the different embodiments or examples described in this specification and the features of the different embodiments or examples.

Notwithstanding the above illustrations and descriptions of the embodiments of the present disclosure, it is understood that the said embodiments are illustrative and cannot be construed as limiting the present disclosure, and those skilled in the art may change, modify, replace and variate the said embodiments within the scope of the present disclosure.

1. An accessory device installed in a drying apparatus capable of emitting airflow and infrared radiation, wherein the accessory comprises:
a mounting portion configured for attaching to the drying apparatus;
an airflow portion comprising an air inlet, a guide chamber and an air outlet, wherein a hollow portion through which the infrared radiation passes is configured between the airflow portion and the mounting portion; and
a guide component located in the guide chamber; wherein
the mounting portion and the airflow portion are connected to each other by a first connector spanning through an internal space of the hollow portion, and the airflow portion is connected to the guide component by a second connector.

2. The accessory device of claim 1, wherein
the first connector is directly connected to the second connector; and/or
the first connector and the second connector are connected on opposite side walls of a same position of the airflow portion.

3. The accessory device of claim 1, wherein the first connector and the second connector have a same direction of extension on any plane perpendicular to an axis of the accessory device; or
in any plane perpendicular to the axis of the accessory device, the first connector and the second connector extend radially along the accessory device.

4. The accessory device of claim 1, wherein a count of the first connectors is two, and a count of the second connectors is two; and
in any plane perpendicular to an axis of the accessory device, all the first connectors and the second connectors are arranged in a straight radial line along the accessory device.

5. The accessory device of claim 1, wherein at least part of the first connector is bent and arched along a direction of airflow, or at least part of the second connector is bent and arched along a direction of airflow.

6. (canceled)

7. The accessory device of claim 1, further comprising a blocking piece formed by a heat-resistant material and/or a reflective material, wherein the blocking piece comprises:
a first blocking portion covering an outer edge of the air inlet and configured for shielding the infrared radiation for the airflow portion;
a second blocking portion spanning through an internal space of the hollow portion and constituting the first connector; and
a third blocking portion covering an end face of the mounting portion facing the drying apparatus and configured for shielding the infrared radiation for the mounting portion.

8. The accessory device of claim 7, wherein the first blocking portion and the third blocking portion are annular, and the second blocking portion is connected radially with the first blocking portion and the third blocking portion.

9. The accessory device of claim 7, wherein part of the second blocking portion is bent and arched along a direction of airflow, and the blocking piece is installed in the airflow portion.

10. The accessory device of claim 1, wherein the airflow portion comprises:
an air inlet portion, wherein one end of the air inlet portion forms the air inlet, and a radial size of the air inlet portion gradually shrinks along a direction of airflow; and
a diffusion portion, wherein one end of the diffusion portion is connected to the air inlet, the other end forms the air outlet, and along the direction of the airflow, a size of the diffusion portion gradually expands in at least one direction.

11. The accessory device of claim 10, wherein the diffusion portion is gradually enlarged in size in a first direction, and the first connector and the second connector extend along the first direction;
along the direction of the airflow, dimensions of the diffusion portion remain unchanged in a second direction, and the second direction is perpendicular to the first direction.

12. (canceled)

13. The accessory device of claim 10, wherein the guide component comprises:
a first diversion portion, wherein at least part of the first diversion portion is located in the air inlet portion, and a radial size of the first diversion portion is gradually shrunk along the direction of airflow; and
a second diversion portion, wherein at least part of the second diversion portion is located in the diffusion portion, and the second diversion portion separates the guide chamber into two parts.

14. (canceled)

15. The accessory device of claim 13, wherein the first diversion portion is conical, and an end of the first diversion portion extends to form a first tip pointing to the air outlet; and
along the direction of airflow:
an end of the second diversion portion gradually shrinks in size in the first direction and forms a second tip pointing to the air outlet; and
the diffusion portion gradually expands in a direction of a first dimension.

16. (canceled)

17. The accessory device of claim 15, wherein the guide component and the guide chamber are axisymmetric structures and have a same axis of symmetry; and
ends of the first tip and the second tip are all positioned on the axis of symmetry.

18. The accessory device of claim 13, wherein the second diversion portion is plate-shaped, and at least part of the second diversion portion remains unchanged in size in a second direction.

19. (canceled)

20. The accessory device of claim 10, wherein in a radial direction of the accessory device, a part of an outer edge of the second connector is connected to an inner wall of the air inlet portion, and the other part extends into the diffusion portion.

21. The accessory device of claim 10, wherein along the direction of the airflow, one end of an outer edge of the second connector is located in the air inlet, and the other end is located in the diffusion portion.

22. The accessory device of claim 13, wherein in a radial direction of the accessory device, an inner edge of the second connector is connected to the first diversion portion; and
along a direction of an outer edge of the accessory device pointing to the inner edge of the accessory device, the accessory device is gradually away from the air inlet.

23. The accessory device of claim 1, wherein the airflow portion has an outer side wall and an inner side wall at a part adjacent to the air inlet, the air inlet is formed inside the inner side wall, and a thermal insulation chamber is configured between the inner side wall and the outer side wall.

24-26. (canceled)

27. The accessory device of claim 1, wherein the guide component is located on an axis of the airflow portion, and an annular air inlet is configured between the guide component and the airflow portion.

28. (canceled)

29. (canceled)

30. A drying assembly, comprising:
a drying apparatus, wherein an end of the drying apparatus is configured with an air outlet portion for emitting airflow and a radiation element for emitting infrared radiation; and
the accessory device of claim 1, which is detachably attached to the drying apparatus, wherein the air inlet corresponds to the air outlet portion, and the hollow portion corresponds to at least part of the radiation element.

31. (canceled)

32. (canceled)
